(19) United States
(12) Patent Application Publication
(10) Pub. No.: US 2006/0012542 A1
(43) Pub. Date: Jan. 19, 2006

(54) Multiple program and 3D display screen and variable resolution apparatus and process

(76) Inventor: Ray M. Alden, Raleigh, NC (US)

Correspondence Address: Ray M. Alden, 808 Lake Brandon Trail, Raleigh, NC, 27610, US

(21) Appl. No.: 11/050,619

(22) Filed: Feb. 2, 2005

Related U.S. Application Data
(63) Continuation-in-part of application No. 10/884,423, filed on Jul. 3, 2004.
(63) Continuation-in-part of application No. 10/994,556, filed on Nov. 22, 2004.

(51) Int. Cl. G09G 3/00

(52) U.S. Cl. 345/32

(57) ABSTRACT

In a first preferred embodiment, this invention provides a low cost means for reliably producing an auto-stereoscopic 3D front project display screen. The screen is engineered to distribute discrete portions of light across a range of discrete horizontal on and off axis viewing angles corresponding with perspective correct 3D images. The screen also distributes each of these pixels concurrently through a wide vertical range to enable users in vertical on axis and off axis viewing positions to see the pixels within their narrow horizontal field of vie yet through a wide vertical field of view. In a second embodiment, a 3D filter is provided that enables a display to automatically switch between displaying 3D media of a first 3D resolution and to display 3D media of a second 3D resolution. Both embodiments also enable multiple users to concurrently watch different programs on the same display at the same time.

### CROSS-REFERENCE TO RELATED APPLICATIONS

This application is a continuation in part of the following patent applications by the present applicant; U.S. application Ser. No. 10/884,423 filed Jul. 03, 2004, and U.S. application Ser. No. 10/994,556 filed Nov. 22, 2004.

### BACKGROUND FIELD OF INVENTION

Modern video display devices incorporate many technologies and methods for providing high quality video to users. Nearly every household in the United States has one or more video displays in the form of a television or a computer monitor. These devices generally use technologies such as Cathode Ray Tubes (CRT) tubes, FEDs, Liquid Crystal Displays (LCD), OLEDs, Plasma, Lasers, LCoS, Digital Micromirror Devices (DMD), front projection, rear projection, or direct view in one way or another. Large monitors offer the advantage of enabling many users to see the video monitor simultaneously as in a living room television application for example. Often video users do not want to view the same image streams as one another. Instead viewers would often like to see completely different programs or image streams at the same time. Alternately viewers would like to see the same program in 3D (three-dimensional) format. Moreover, people would like to enjoy high resolution images on their video monitors.

The present invention provides a significant step forward for video displays. The present invention describes display architectures that can be used with many display technologies together with specific implementations including a projector based pixel engine with an actuated reflective lenticular screen and a direct view based pixel engine with an actuated transmissive. The art described herein is suitable for enhancing the performance of many image generators including Cathode Ray Tubes (CRT) tubes, FEDs, Liquid Crystal Displays (LCD), OLEDs, Plasma, Lasers, LCoS, and Digital Micromirror Devices (DMD), and in front projection, rear projection, or direct view applications.

### BACKGROUND-DESCRIPTION OF PRIOR INVENTION

The prior art describes some attempts to enable multiple viewers to see different video streams concurrently on the same monitor. Many are generally drawn to wearing glasses that use polarization or light shutters to filter out the unwanted video stream while enabling the desired video stream to pass to the users' eyes. U.S. Pat. No. 6,188,442 Narayanaswami being one such patent wherein the users wear special glasses to see their respective video streams. U.S. Pat. No. 2,832,821 DuMont does provide a device that enables two viewers to see multiple polarized images from the same polarizing optic concurrently. DuMont however also requires that the viewers use separate polarizing screens as portable viewing aids similar to the glasses. DuMont further requires the expense of using two monitors concurrently. Japanese patent JP409105909A, Yamazaki et al describes a stationary lenticular array as the means to enable multiple program viewing, however the approach requires a corresponding diminution of resolution in direction relationship with the number of programs displayed concurrently. No known prior art provides a technique to enable multiple viewers to view separate video streams and watch auto stereoscopic 3D programs on a display without a diminution of resolution and which is also adapted to provide increased resolution over the capability of the image generator.

The so called “Cambridge Display” or “Travis Display” provides a well publicized means for using time sequential spatially multiplexed viewing zones as a method to enable multiple viewers to see auto-stereoscopic 3-D images on a display. This technique is described in U.S. Pat. Nos.; 5,132,839 Travis 1992, 6,115,059 Son et al 2000, and 6,533,420 Eichenlaub 2003. The technique is also described in other documents including; “A time sequenced multi-projector auto-stereoscopic display”, Dodgson et al, Journal of the Society for Information Display 8(2), 2000, pp 169-176; “A 50 inch time-multiplexed auto-stereoscopic display” Proceedings SPIE Vol 3957, 24-26 Jan. 2000, San Jose Calif., Dodgson, N. A., et al.; Proceedings SPIE Vol 2653, Jan. 28-Feb. 2, 1996, San Jose, Calif., Moore, J. R., et al.; and can be viewed at http://www.cl.cam.ac.uk/Research/Rainbow/projects/asd.html. This prior art typically relies on optics to first compress the entire image from a pixel generator such as a CRT tube, secondly an optical element such as a shutter operates as a moving aperture that selects which orientation of the entire compressed image can pass therethrough, thirdly, additional optics magnify the entire image, and fourthly the image is presented to a portion of viewer space. This process is repeated at a rate of approximately 60 hertz with the shutter mechanism operating in sync with the pixel generator to present different 3D views to different respective portions of viewer space. Two main disadvantages of this prior art are easily observable when viewing their prototypes. A first disadvantage is that a large distance on the order of feet is required between the first set of optics and the steering means, and between the steering means and the second set of optics. This disadvantage results in a display that is far too bulky for consumer markets or for any flat panel display embodiments. Secondly, looking at the display through large distances between optics creates a tunnel effect that tends to diminish the apparent viewable surface area of the resultant viewing screen.

According to Deep Light of Hollywood, Calif., the intellectual property comprising the “Cambridge display” is owned and being advanced by Deep Light. Also Physical Optics Corporation describes on their website that they are currently building a prototype of a time sequenced 3D display using liquid crystal beam steering at the pixel level similarly to that which has been described by the present applicant in the related applications referenced in this document.

Also Hewlett Packard has announced a “wobleation” process that physically moves a DLP image generator having a first resolution through a tiny position cycle in sync with driving it to produce every alternate pixel at a faster generation rate with the result being a higher second resolution image being projected on a diffuse surface. Increasing resolution using this methodology requires optics to manipulate the image at the sub pixel level or alternately, larger distances between pixel at the chip level, thus the actuation of the DLP chip approach to increasing resolution is not easily upgradeable without substantial cost to a user. Also, the method developed by HP requires a predefinition of what the maximum resolution of the display will be. Whereas the present invention discloses a means to change the resolution of the display on the fly as a function of the resolution of the image being displayed.

By contrast the present invention describes an actuate-able reflective lenticular or transmissive lenticular where the lenticular width is equal to the number of perspectives generated in the 3D application times the width of an individual pixel. The lenticular is then actuated perpendicular to the image the width of the lenticular in 1 pixel width increments. In the multiple program application, the lenticular is actuated perpendicular to the image a minimum distance of one lenticular width divided by the number of programs presented concurrently. Embodiments relying upon a reflective screen and a transmissive optic are described. The present invention also can increase the resolution of the image by producing images at higher speeds and actuating the lenticular less than one pixel width.

The present invention provides integration of multiple image perspectives and/or multiple programs in a novel manner and the presentation of the images to multiple viewers. The system provides a display for enabling multiple users to watch multiple 2-D or 3-D programs on the same display at the same time, full screen and full resolution.

Other relevant disclosures have been made by the present applicant including those cited at the beginning of this document which are incorporated herein by reference.

### BRIEF SUMMARY

The invention described herein represents a significant improvement for the users of displays. In a first reflective embodiment, a front projection screen with integral horizontal and vertical lenticulars is provided to enable multiple users to concurrently watch completely different programs including auto-stereoscopic 3D programs in a large venue format which is highly reliable and cheap to produce. In a second transmissive embodiment, a front projection or front view screen with an integral variable filter methodology and apparatus is provided to enable multiple users to concurrently watch completely different programs including auto-stereoscopic 3D programs with the 3D resolution varying according to the media being played in a format which is highly reliable and cheap to produce.

Thus the present invention offers a significant advancement in displays functionality and availability to large mass markets.

Objects and Advantages

Accordingly, several objects and advantages of the present invention are apparent. It is an object of the present invention to provide an image display means which enables multiple viewers to experience completely different video streams simultaneously. This enables families to spend more time together while simultaneously independently experiencing different visual media or while working on different projects in the presence of one another or alternately to concurrently experience auto stereoscopic 3D media with their unaided eyes. Also, electrical energy can be saved by concentrating visible light energy from a display into narrower user space where a user is positioned. Likewise when multiple users use the same display instead of going into a different room, less electric lighting is required. Also, by enabling one display to operate as multiple displays, living space can be conserved which would otherwise be cluttered with a multitude of displays.

It is an advantage that the present invention doesn't require special eyewear, eyeglasses, goggles, or portable viewing devices as does the prior art.

It is an advantage of the present invention that the same monitor that presents multiple positionally segmented image streams also can provide true positionally segmented auto stereoscopic 3D images as well as stereoscopic images and well as standard 2D images.

It is an advantage of the present invention that no moving parts are employed.

It is an advantage that the lenticular reflecting screen is cheap to produce and very reliable.

Further objects and advantages will become apparent from the enclosed figures and specifications.

### DRAWING FIGURES

FIG. 1a Prior Art—depicts a top view of a lenticular lens 3D pixel.

FIG. 1b Prior Art—depicts a top view of a screen filter 3D pixel.

FIG. 1c—depicts a top view of a concave reflecting lenticular 3D pixel.

FIG. 1d—depicts a top view of a convex reflecting lenticular 3D pixel.

FIG. 2a—depicts a prospective view of a horizontally concave reflecting lenticular 3D pixel.

FIG. 2b—illustrates the vertically concave reflecting properties of the horizontally concave reflecting lenticular 3D pixel of FIG. 2a.

FIG. 2c—depicts a prospective view of a horizontally convex reflecting lenticular 3D pixel.

FIG. 2d—illustrates the vertically convex reflecting properties of the horizontally convex reflecting lenticular 3D pixel of FIG. 2c.

FIG. 3a illustrates a method of manufacture of a projection screen.

FIG. 3b is a section of reflecting lenticular screen for the first embodiment.

FIG. 4a illustrates a transparent horizontal lenticular combined with a vertical reflective lenticular 3D pixel.

FIG. 4b is the side view of the transparent lenticular of FIG. 4a.

FIG. 4c is a top view of the transparent lenticular of FIG. 4a.

FIG. 4d is an alternate configuration of the transparent lenticular with reflective lenticular in combination.

FIG. 5 illustrate a reflective lenticular 3D pixel within a square geometry.

FIG. 6a illustrates a variable filter screen display in 2D embodiment.

FIG. 6b illustrates a variable filter screen display operating for higher 3D resolution.

FIG. 6c illustrates a variable filter screen display operating for lower 3D resolution.

### DETAILED DESCRIPTION OF THE INVENTION

### First Embodiment—Preferred

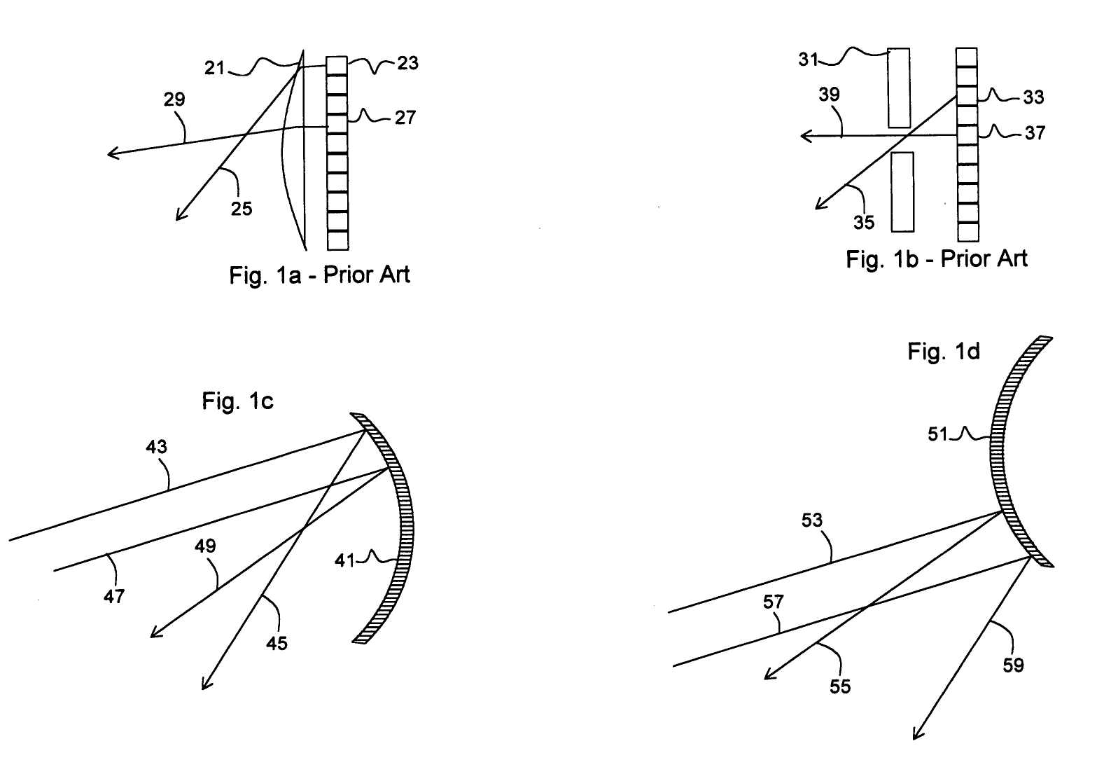

FIG. 1a Prior Art—depicts a top view of a lenticular lens 3D pixel. A 3D pixel lenticular lens 21 directs a light from a first lens sub pixel 23 to be a first lens directed perspective 25. The 3D pixel lenticular lens 21 directs a light from a second lens sub pixel 27 to be a second lens directed perspective 29. The 21 similarly directs light from multiple sub pixels into respective sections of user space. Depending upon a user's position, she will see one or two perspectives coming from the 21 lenticular and from thousands of similar 3D pixel lens lenticulars and thereby experience a 3D perspective. Similarly, according to multiple patent disclosures by the present application, the 29 can represent a first program and the 25 can represent a second program such that a first user will see a first program from the 29 and thousands of other sub-pixels while a second user sees a second program from the 25 and thousands of similar sub-pixels. The lenticular lens based system requires collimated pixels.

FIG. 1b Prior Art—depicts a top view of a screen filter 3D pixel. A 3D pixel filter 31 filters a light from a first filter sub pixel 33 to be a first filter directed perspective 35. The 3D pixel filter 31 directs a light from a second filter sub pixel 37 to be a second filter directed perspective 39. Depending upon a user's position, she will see one or two perspectives coming through the 31 filter and from thousands of similar 3D pixel filter openings and thereby experience a 3D perspective. Similarly, according to the art of the present applicant, the 39 can represent a first program and the 35 can represent a second program such that a first user will see a first program from the 39 and thousands of other sub-pixels while a second user sees a second program from the 35 and thousands of similar sub-pixels. The filter based system is compatible with a wide variety of pixel engines and does not require collimated pixels.

FIG. 1c—depicts a top view of a concave reflecting lenticular 3D pixel. A 3D pixel concave mirror lenticular 41 directs a light from a first concave mirror sub pixel 43 to be a first concave mirror directed perspective 45. The 3D pixel concave mirror 41 directs a light from a second concave mirror sub pixel 47 to be a second concave mirror directed perspective 49. Depending upon a user's position, she will see one or two perspectives coming from the 41 3D concave mirror lenticular and from thousands of similar 3D pixel concave mirror lenticulars and thereby experience a 3D perspective. Similarly, according to the art disclosed by the present applicant in previous applications, the 49 can represent a first program and the 45 can represent a second program such that a first user will see a first program from the 49 and thousands of other sub-pixels while a second user sees a second program from the 45 and thousands of similar sub-pixels. The concave mirror architecture is especially compatible with projection light engines such as a 3 chip DLP; the 43 and 47 being two of thousands of pixels produced by the DLP and directed to an array of similar reflective lenticulars (not shown).

FIG. 1d—depicts a top view of a convex reflecting lenticular 3D pixel. A 3D pixel convex mirror lenticular 51 directs a light from a first convex mirror sub pixel 53 to be a first convex mirror directed perspective 55. The 3D pixel convex mirror 51 directs a light from a second convex mirror sub pixel 57 to be a second convex mirror directed perspective 59. Depending upon a user's position, she will see one or two perspectives coming from the 51 convex mirror lenticular and from thousands of similar 3D pixel convex mirror lenticulars and thereby experience a 3D perspective. Similarly, the 59 can represent a first program and the 55 can represent a second program such that a first user will see a first program from the 59 and thousands of other sub-pixels while a second user sees a second program from the 55 and thousands of similar sub-pixels. The convex mirror architecture is especially compatible with projection light engines such as a 3 chip DLP; the 53 and 57 being two of thousands of pixels produced by the DLP and directed to an array of reflecting lenticulars similar to the 51 (not shown).

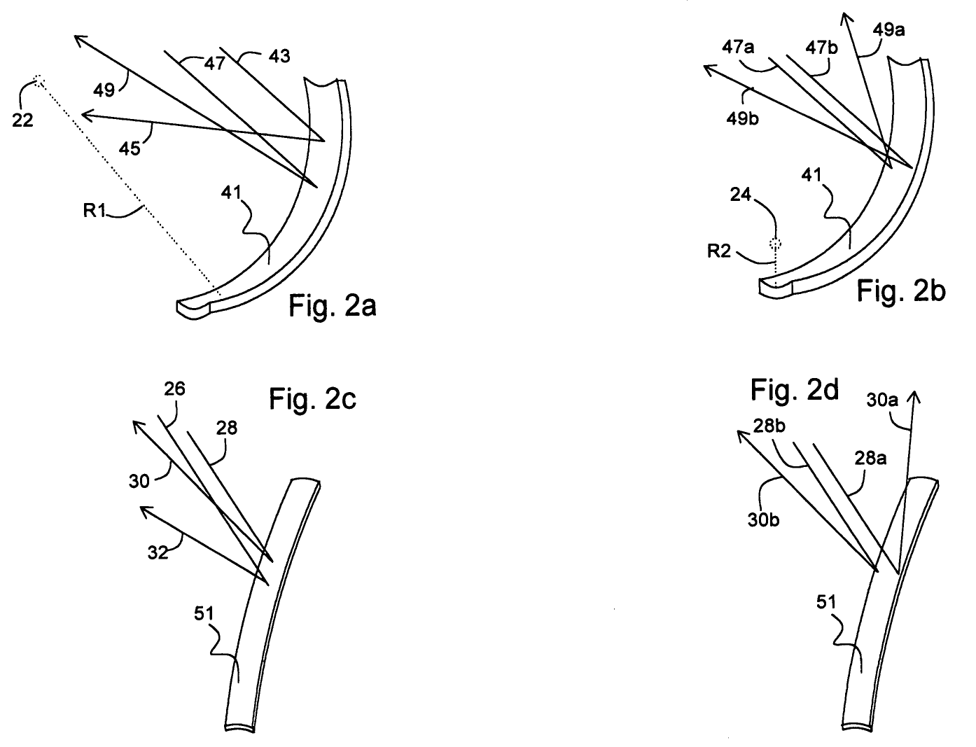

FIG. 2a—depicts a prospective view of a horizontally concave reflecting lenticular 3D pixel. In FIG. 2a, the convex 3D pixel convex mirror of FIG. 1c seen from a prospective view illustrates how its horizontal curvature distributes incident light in the horizontal plane. While incident light such as the 47 and the 43 are nearly parallel prior to incidence, the horizontal curvature causes them to cross after incidence. A horizontal center of curvature 22 exists and is located at a horizontal curvature radius R1 distance from the 41. In practice, the curvature of 41 may not be an arc portion of a circle with a single radius R1 but may be shaped with alternate curvature so as to distribute light throughout the user space according to the shape of the user space. A discussion of how to shape reflectors to optimize light distribution within the user space is contained within patent application Ser. Nos. 10/884,423 filed Jul. 3, 2004 and 10/994,556 filed Nov. 22, 2004 which are incorporated herein by reference. Due to the horizontal curvature of 41, every user within the user space will be able to see light coming from the 41 3D pixel regardless of their horizontal position. Note that as described in FIG. 2c, the horizontal curvature can be concave or convex. A user of an array of pixels similar to 41 can see auto stereoscopic 3D images or multiple users of such a screen can each watch different programs on the same screen concurrently (according to the present applications disclosure referenced herein). Also, while only two sub pixels are shown as being incident upon the 41, the number of pixels will equal the number of perspectives the display use to show it stereoscopic or auto stereoscopic images.

FIG. 2b—illustrates the vertically concave reflecting properties of the horizontally concave reflecting lenticular 3D pixel of FIG. 2a. The convex 3D pixel convex mirror of FIG. 2a illustrates how its horizontal curvature distributes incident light in the vertical plane. While the horizontal curvature distributes different incident sub-pixels to discrete horizontal sections of the user space, the vertical curvature distributes each of these same pixels to be seen through a wide range of positions in a vertical plane. The 47 sub-pixel incident light of FIG. 2a actually represents a light bundle which is incident upon the entire height of 41. This illustrates the scale of the size of the 41. The 41 is several sub-pixels wide while being no greater than one sub pixel tall. The 41 has a vertical concavity which comprises an arc with a vertical concavity center point 24 located a radius distance of R2 from the 41. The vertical curvature of 41 is for the purpose of distributing each incident sub pixel light throughout a tall enough vertical plane to ensure that all users within the vertical plane will be able to see the sub pixel. In a living room application for example, the vertical view range that each sub pixel must cover may be represented by some people may be laying on the floor while others are sitting on the couch and still others are standing. Thus different portions of the 47 light bundle are directed to different portions of a vertical plane including a lower portion of the sub pixel 47a being directed as a reflected upper portion of sub pixel 49a and an upper portion of the sub pixel 47b being directed as a reflected lower portion of sub pixel 49b. Thus the vertical curvature of 41 acts as a directional light diffuser but only in the vertical plane. In practice, the vertical curvature of 41 may not be an arc portion of a circle with a single radius R2 but may be shaped with alternate curvatures so as to distribute light throughout the vertical plane more efficiently. A discussion of how to shape reflectors to optimize light distribution within the user space is contained within patent application Ser. Nos. 10/884,423 filed Jul. 3, 2004 and 10/994,556 filed Nov. 22, 2004 which are incorporated herein by reference. Due to the vertical curvature of 41, every user within the user space will be able to see light coming from the 41 3D pixel regardless of their vertical position. Note that as described in FIG. 2d, the vertical curvature can be concave or convex. Note that while 45 and 49 of FIG. 1c comprise separate distinct light information, 49a and 49b comprise the same light information.

FIG. 2c—depicts a prospective view of a horizontally convex reflecting lenticular 3D pixel. The horizontal curvature of the 51 causes incident sub pixels to be distributed to different portions of user space including first DLP pixel 26 which is reflected as first reflected DLP pixel 32 to a first portion of user space and second DLP pixel 28 which is reflected as second reflected DLP pixel 30 to a second portion of user space. Thus different portions of user space can be addressed by convex lenticular reflector arrays for providing multiple programs or auto stereoscopic programs just as can be achieved with concave lenticular arrays as in FIG. 2a.

FIG. 2d—illustrates the vertically convex reflecting properties of the horizontally convex reflecting lenticular 3D pixel of FIG. 2c. Thus different portions of the 28 light bundle are directed to different portions of a vertical plane including a upper portion of the DLP sub pixel 28a being directed as a reflected upper portion of DLP sub pixel 30a and a lower portion of the DLP sub pixel 28b being directed as a reflected lower portion of DLP sub pixel 28b. Thus the vertical curvature of 41 acts as a directional light diffuser but only in the vertical plane. Note that while 55 and 59 of FIG. 1d comprise separate distinct light information, 30a and 30b comprise the same light information. Thus different portions of user space can be addressed by convex lenticular reflector arrays for providing multiple programs or auto stereoscopic programs just as can be achieved with concave lenticular arrays as in FIG. 2b.

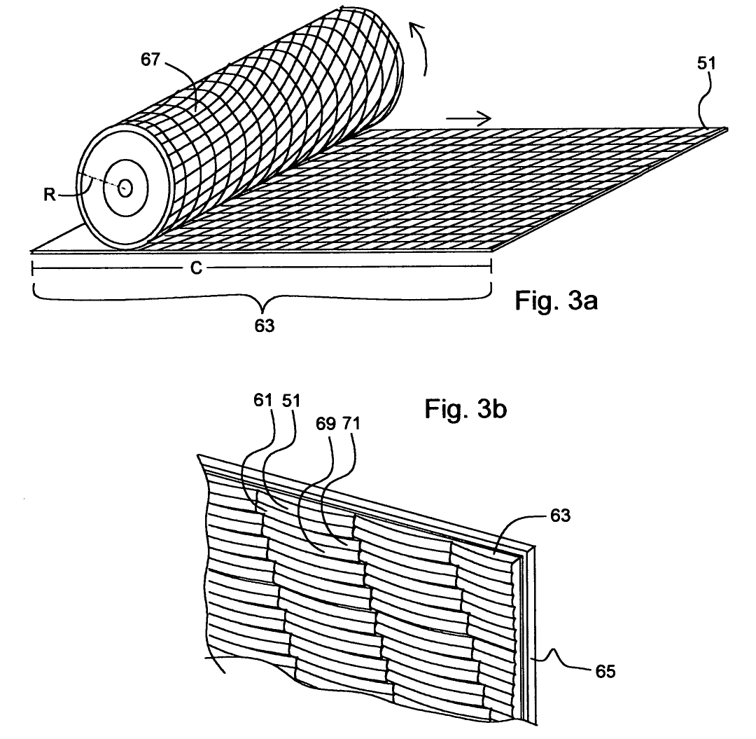

FIG. 3a illustrates a method of manufacture of a projection screen. An embossed roller 67 is used to impress in plastic a lenticular pattern to form a reflective projection screen 63. The 63 containing thousands of lenticulars similar to 51 (except lenticulars may vary throughout the screen potentially having differing horizontal and/or vertical curvatures and/or angular positions.) Once the pattern is embossed into the 63, the 63 is plated with a reflective coat. Since the curvatures of the reflecting lenticulars in 63 can vary from center to each side so as to efficiently address the user space horizontally and also may vary from top to bottom so as to address the user space efficiently vertically, it is recommended that the 67 have a circumference C equal to the length of 63. In this scenario the length of 63 can be calculated using the radius R of the 67 as follows, C=2*pi*R and the length of 67 also equaling the height of the 63. Thus, the roller can create the exact vertical and horizontal curvature shapes on the surface of the plastic for the 63 in a process that can be automated and executed in a mass production environment where 63 is a plastic substrate capable or receiving and retaining the embossed shapes imposed by the 67.

FIG. 3b is a section of reflecting lenticular screen for the first embodiment. The 51 convex lenticular sits atop and is vertically in line with an identical second convex lenticular 61. The 61 and 51 together perform some redundancy with one another each directing light horizontally to the same sections of user space and also each distributing light equitably through the vertical plane. Note that two convex lenticulars including a third convex lenticular 71 and a fourth convex lenticular 69 are vertically offset from the 61 and 51 pair by a horizontal distance equal to one sub-pixel. This is done to ensure that horizontal gaps between different sets of lenticular reflectors do not become a noticeable flaw to any one set of users but instead are distributed equally through the user space so as to be less observable. After the lenticulars are embossed according to FIG. 3a, the sheet is laminated to a secondary substrate 65 to ensure its optical integrity and physical durability throughout a lifetime of use. The 65 being a rigid or semi-rigid flat plastic sheet. The 63 can be manufactured according to FIG. 3a or according to processes well known in the art of plastic reflective optic and plastic lenticular fabrication.

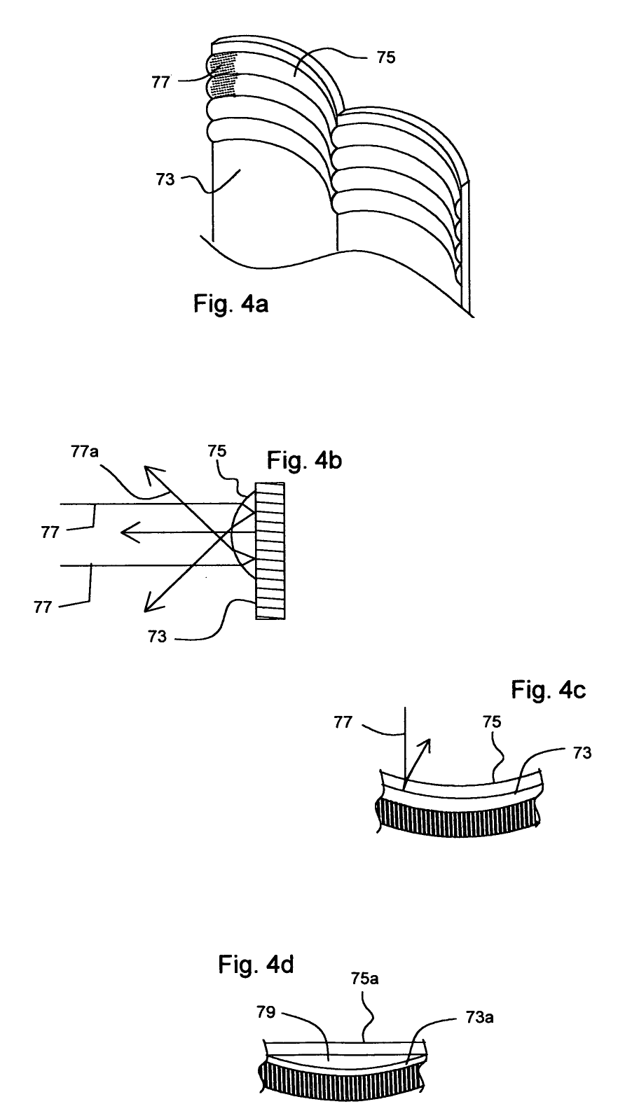

FIG. 4a illustrates a transparent horizontal lenticular combined with a vertical reflective lenticular 3D pixel. While the previous Figures herein describe reflecting lenticulars that have vertical and horizontal curvatures as the means to distribute light predictably as desired throughout the user space, FIGS. 4a, 4b, 4c, and 4d, describe how a similar effect can be achieved using a fabricated combination of a reflecting lenticular array together with a transmissive lenticular array. A reflecting lenticular 73 is one of many reflecting lenticulars lined up side by side and each having a horizontal curvature. If the image to be projected onto a reflective screen comprising 73 and the other similar lenticulars is to represent nine different 3D viewing perspectives then the 73 is equal to nine pixels wide. Its height is the height of the viewing screen. As described in FIG. 1c, the horizontal curvature will distribute light horizontally such that each pixel representing a different perspective will be reflected off of the 73 to a respective portion of viewer space. Adhered to the surface of the reflective surface of 73 is a sheet of horizontal lenticular film including a single horizontal lenticular lens 75. Both the horizontal lenticular film and the vertical reflective lenticular can be manufactured according to FIG. 3a or according to means well known in the art of plastic optic and plastic lenticular film fabrication. After manufacture, the film is adhered to the surface of the reflective lenticular to form the 3D reflective screen that will distribute respective pixels to respective horizontal portions of while also spread each pixel to be viewable within a suitable range of vertical angles. A single pixel 77 is incident upon the 75 and the lenticular immediately below the 75 to be reflected according to FIG. 4b.

FIG. 4b is the side view of the transparent lenticular of FIG. 4a. The 77 pixel is incident upon the 75 transparent lenticular and is refracted prior to being incident upon the 73 reflective surface. The 77 pixel light is reflected by 73 and then refracted again by 75 to be vertically directed in a column throughout the full vertical viewing range of user space comprising a diverging ray bundle including an upper refracted pixel segment 77a. Thus the combination of a reflective lenticular and a transmissive lenticular performs similarly to the vertical and horizontally reflective lenticulars described in FIGS. 2a through 3b. Some manufacturing economies may be derived when manufacturing separately and then assembling together the combination transmissive lenticular array with reflective lenticular array of FIG. 4a compared to producing the reflective lenticular array of FIG. 3b but the opposite may also be true.

FIG. 4c is a top view of the transparent lenticular of FIG. 4a. The incident 77 pixel will be distributed to a desired portion of horizontal space after it passes through the 75, is reflected by the 73 and then passes back through the 75.

FIG. 4d is an alternate configuration of the transparent lenticular with reflective lenticular in combination. It is possible for ease of combining an alternate horizontal transparent lenticular film 75a to a reflective lenticular array including an alternate reflective lenticular 73a to fill the concavity within the 73a with a transparent substrate 79 first and to then adhere the alternate horizontal transparent lenticular film 75a to the surface of the 79. This additional step of filling the concavities makes for a much easier installation of a transparent lenticular film in front of a reflective lenticular array while producing a reliable means to distribute discrete pixels to discrete horizontal positions while concurrently spreading al pixels to fill the entire vertical range of viewing positions. Thus the alternate horizontal lenticular film 75a can be installed on a completely flat surface comprising many sections similar to 79 to be combined with the alternate lenticular concave reflector 73a

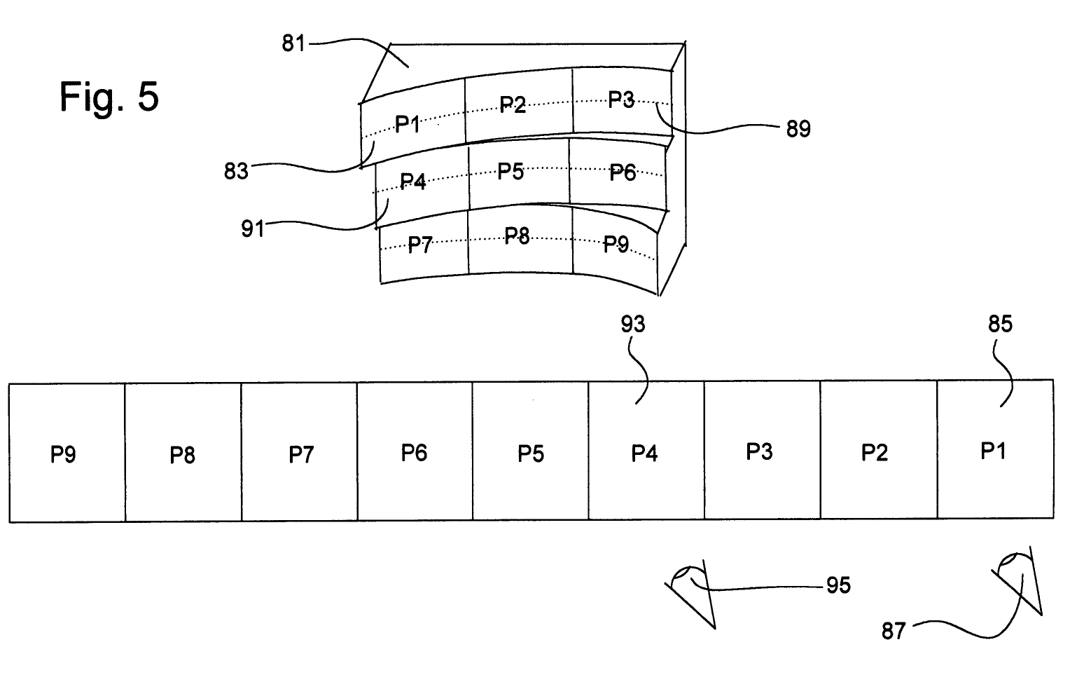

FIG. 5 illustrate a reflective lenticular 3D pixel within a square geometry. While the 3D pixels discussed thus far have comprised several sub pixels side by side as the means to distribute discreet sub pixel light to discreet portions of user space. It is possible for efficiency to also construct a 3D pixel as a stack such that discrete portions of user space are addressed by discrete levels in the stack as well as discrete portions side by side. A stacked reflective 3D pixel 81 comprises a top reflective layer 83 which has a horizontal curvature and a middle reflective layer 91 which has a horizontal curvature. Sub pixels P1, P2, and P3 are incident upon the 83 and directed to discrete portions of user space including for example the P1 section of user space 85. A user's right eye 87 receives the P1 light from the 81 3D pixel. A series of additional sub pixels including sub pixel P4, P5, and P6 are all incident upon the 91 before being directed to discrete portion of user space including user space P4 for example where it is observed by the first user's left eye 95. Thus, the first user sees two different perspective from the same 81 3D pixel. Many thousands of similar 3D pixels operating concurrently will give the user an auto stereoscopic 3D experience. Also P4 and P1 could each represent different programs in which case two users positioned differently form the first user could each watch completely different programs on the display at the same time. For example sub pixels P1 through P4 could reflect a first program's pixel and pixels P6 through P9 could reflect a second program's pixel and thousands and similar 3D pixels can similarly reflect two different programs whereby two users can watch two completely different programs concurrently due to the horizontal segmentation of the viewer space (this has been abundantly described by the present applicant in prior applications referenced herein.) Also, a vertical light diffuser 89 is present on the surface to distribute light through a wide vertical range. The 89 can comprise the transparent lenticular of FIGS. 4a through 4d, a curvature within the reflective lenticular as described in FIGS. 2a through 2d, or an engrained diffuser capable of diffusing light in the vertical plane but not in the horizontal plane. Transparent films with such diffusing properties that can be adhered to the surface according to FIGS. 4a through 4d have been described by 3M and Physical Optics Corporation. Note that the art described in all Figures herein will distribute sub pixels horizontally to discrete portions of user space according to the pixels described in FIG. 5 and comprising the 85 and 93. Thus each users' eyes will see only one sub pixel from each 3D pixel the sub pixels representing different perspectives of a 3D image and/or different pixels in different program content. Further, the art described in FIGS. 2a through 6c will distribute sub pixels vertically in taller columns than is described in FIG. 5 including 85 and 93 such that viewers throughout the complete vertical viewing range will be able to see light from every 3D pixel which corresponds with a set of respective horizontal perspectives. Each sub pixel having a narrow horizontal field of view and a tall vertical field of view.

### Second Embodiment

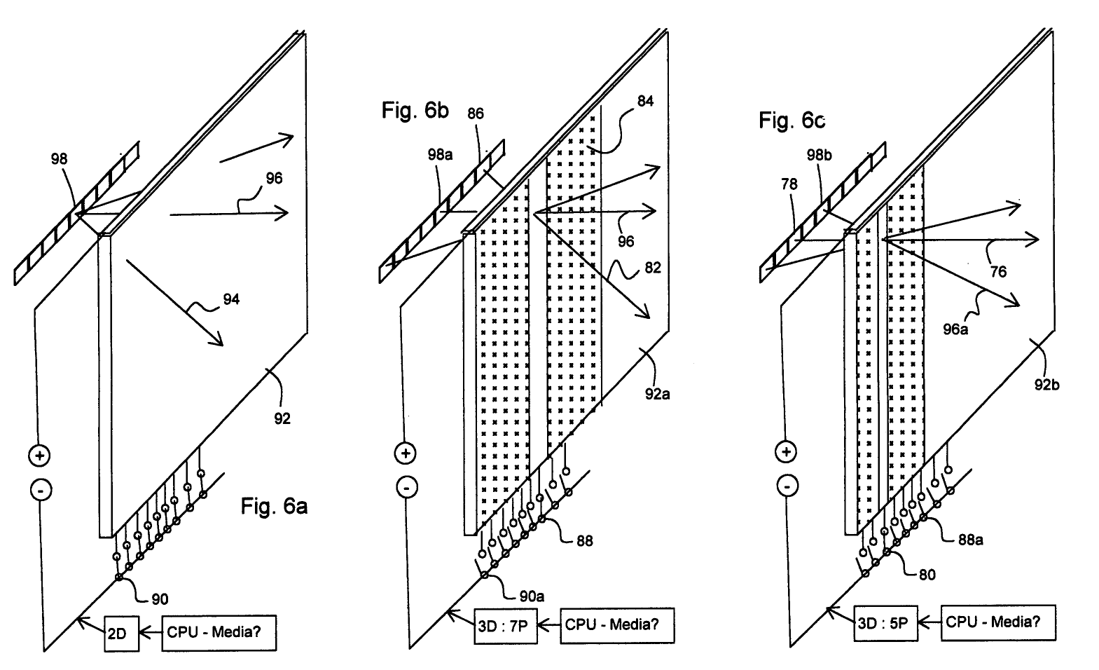

FIG. 6a illustrates a variable filter screen display in 2D mode. As described in FIG. 1b Prior Art, it is well known to provide a filter as a means to present 3D images. FIGS. 6a through 6c describe a filter method that comprises a variable filter width means to accommodate 3D video across a range of 3D resolutions. FIG. 6a describes a variable filter array 92 in an “on” state such that it is transparent throughout. The 92 can be comprised of one or more technologies that can be caused to change between transparent and opaque (or translucent) states such as an electro chromatic cell array or a liquid crystal cell array. All switches including a first switch in on state 90 are in the on state such that light from a pixel array including a first diffuse pixel 98 is able to travel through the surface of the 92 and into user space. This configuration is suitable for displaying 2D images since users across a wide range of viewing positions can see all of the pixels at full resolution. Note that a CPU detects that 2D media is to be displayed and so causes the 92 to be switched to the full transparent state.

FIG. 6b illustrates a variable filter screen display operating for higher 3D resolution. The CPU detects that 3D media is to be displayed with a 3D horizontal resolution of seven perspectives per 3D pixel and so causes the filter screen to be switched into filter screen in seven pixel resolution mode 92a. To achieve this the CPU calculates that every 7^{th} column of the 92a needs to remain transparent while all other columns will be opaque. Thus the switches are set according to instructions by the CPU such as first switch in off state 90a which causes the first column to be opaque and second switch in on state 88 which causes a portion of the filter screen to be transparent. The distance between the pixels such as first 3D filtered pixel 98a and the 92a can also be changed depending upon the media being played (the CPU may also determine how the distance between the pixel light sources and the 92a filter array needs to be adjusted). Light from the 98a is absorbed by the first filter configuration 84 except through the narrow transparent column such that on axis ray 96 can fit through but most of the off axis light from 98a can not get through. Similarly, light from an off axis pixel 86 is generally absorbed by the 84 filter except through a narrow range to exit as off axis ray 82. Thus, the display in FIG. 6a that detected and displayed 2D media has detected and displayed 3D seven perspective resolution media in FIG. 6b and can also detect and display 3D five perspective media as described in FIG. 6c. This ability to switch between different media is very valuable since presently many differing 3D displays are emerging that will display specific configurations of 3D images based for example on differing numbers of perspectives of resolution but no 3D display is available that can display 3D images across a range of different configurations and differing perspective resolutions.

FIG. 6c illustrates a variable filter screen display operating for lower 3D resolution. The CPU detects that 3D media is to be displayed with a 3D horizontal resolution of five perspectives per 3D pixel and so causes the filter screen to be switched into filter screen in five pixel resolution mode 92b. To achieve this the CPU calculates that every 5^{th} column of the 92b needs to remain transparent while all other columns will be opaque. Thus the switches are set accordingly such as third switch in on state 80 and second switch in off state 88a. The distance between the pixels such as second 3D filtered pixel 98b and the 92b can also be changed depending upon the media being played. Light from the 98b is absorbed by the second filter configuration except through the narrow transparent column such that second off axis ray 96a can fit through but most of the light from 98b can not get through. Similarly, light from a second on axis pixel 78 is generally absorbed by the filter except through a narrow range to exit as second on axis ray 76. Thus, the display in FIG. 6a that detected and displayed 2D media has detected and displayed 3D seven perspective resolution media in FIG. 6b and can also detect and display 3D five perspective media as described in FIG. 6c. Thus, this variable filter method can be automatically switched in real time to display 2D and 3D media of differing resolutions and intended for many types of 3D and 2D displays.

Operation of the Invention

Operation of the invention has been discussed under the above heading and is not repeated here to avoid redundancy.

Conclusion, Ramifications, and Scope

Thus the reader will see that the Multiple Program and 3D Display Screen and Variable Resolution Apparatus and Process of this invention provides a novel unanticipated, highly functional and reliable means for producing multiple functionalities in a first reflective lenticular screen embodiment and variable 3D resolutions in a second variable display filter embodiment. The former providing a cost effective front projection auto stereoscopic display that also functions as a multiple program display and can play 2D media as well. The later providing a cost effective reliable means for enabling a single display to play a wide range of media intended for 2D displays or media of many configurations and 3D resolutions.

While the above description describes many specifications, these should not be construed as limitations on the scope of the invention, but rather as an exemplification of a preferred embodiment thereof Many other variations are possible for example:

The prior related patent applications of the present applicant which are cross referenced herein also contain relevant information which is incorporated herein by reference but not repeated to avoid redundancy.

What is claimed:

1. A reflective display screen adopted for displaying at least one type of media selected from the group consisting of; 3D media, stereoscopic media, auto stereoscopic 3D media, and multiple concurrent media, comprising:
a first reflective element having a horizontal curvature,
a plurality of at least a first pixel and a second pixel both incident upon said first reflecting element,
and at least one element selected from the group consisting of, a vertical curvature, a lens, and an optical film,
wherein said horizontal curvature of said first reflecting element causes said first pixel to be reflected into a first horizontally narrow field of view and said curvature of said first reflecting element causes said second pixel to be reflected into a second horizontally narrow field of view, and said selected element causes said first pixel to be more vertically divergent than it is horizontally divergent.

2. A method of segmenting images for presentation to an audience comprising the steps of,
providing a first reflector,
providing a second reflector,
providing a first pixel,
providing a second pixel,
wherein said first reflector is provided with a first combination of curvature and position and from which said first pixel is directed to diverge into a first narrow predefined horizontal off axis field of view and said first reflector is provided with at least one element selected from the group consisting of, a vertical curvature, a lens, and an optical film, which causes the first narrowly divergent horizontal pixel to be more widely divergent in a vertical field of view, and
wherein in said second reflector is provided with a second combination of curvature and position and from which said second pixel is directed to diverge into a second narrow predefined horizontal off axis field of view and said second reflector is provided with at least one element selected from the group consisting of; a vertical curvature, a lens, and an optical film, which causes the second narrowly divergent horizontal pixel to be more widely divergent in a vertical field of view, and
wherein said first reflector and said second reflector are located adjacent to one another on a reflective display screen.

3. A method of varying the resolution of display comprising the steps of,
providing a light filter,
providing a means for switching sand light filter into at least two filter configurations,
wherein said filter can be switched to a first configuration to display lower resolution 3D images and said filter can be switched a second configuration to display lower resolution 3D images.
